(19) United States
(12) Patent Application Publication
(10) Pub. No.: US 2016/0314437 A1
(43) Pub. Date: Oct. 27, 2016

(54) METHOD FOR USE BY AN EMPLOYER TO IMPLEMENT A PLAN FOR AN EMPLOYEE TO SELF-MANAGE RELOCATION

(71) Applicant: NuCompass Mobility Services, Inc., Pleasanton, CA (US)

(72) Inventors: Frank Patitucci, Pleasanton, CA (US); Elise Riordan, San Ramon, CA (US)

(73) Assignee: NuCompass Mobility Services, Inc., Pleasanton, CA (US)

(21) Appl. No.: 15/136,724

(22) Filed: Apr. 22, 2016

Related U.S. Application Data
(60) Provisional application No. 62/153,255, filed on Apr. 27, 2015.

(51) Int. Cl. G06Q 10/10

(52) U.S. Cl. CPC G06Q 10/1057

(57) ABSTRACT

A method for use by an employer in establishing a plan to enable an employee to self-manage the employee's relocation includes approving service providers for each service to be rendered in the employee's relocation, and then establishing an overall budget to complete the relocation based upon cost estimates from the third party relocation company proprietary database. The employer then grants the employee permission to use the budget and service providers so the employee may thereby self-manage the employee's relocation.

### APPLICATIONS

This application claims priority to U.S. Provisional Patent Application Ser. No. 62/153,255, filed Apr. 27, 2015 and entitled METHOD FOR ESTIMATING EMPLOYEE RELOCATION EXPENSES, the disclosure of which is incorporated herein by reference.

### BACKGROUND AND DETAILED DESCRIPTION OF THE DISCLOSURE

The present disclosure is directed to a relocation plan for use by employers to streamline and economize employee relocation. The cloud-based method disclosed here implements a plan for use by employers, facilitated by a third party relocation company, which provides a platform so that employers interact with and empower their employees to access service providers that the relocation company has investigated and that the employer has approved. An employee is then enabled to self-manage virtually all aspects of the employee's relocation. This is done on the employee's own schedule and dealing with the pre-approved service providers. During this process, the employer maintains full visibility and budget control.

Stated somewhat more in detail, the method described here contemplates that the employer first initiates an employee's move, and then selects the level of assistance and services to be provided, such as transportation, temporary housing, etc. The employer has the option to seek input from the employee regarding the employee's specific circumstances and needs. The employer uses an estimating tool to create a budget calculated for each service, and routes the costs to management, such as a hiring manager, for approval. After approval, a relocation agreement is sent to the employee for approval. After the employee approves, a portal operated by the third party relocation company is activated for use by the employee who can now obtain bids from the service providers, and self-manage which ones to engage and when the services are to be rendered, and arrange payment of allowances and reimbursement of expenses, all upon the employee's own schedule. All service provider invoices approved by the employee are authorized for payment from the pre-approved budget, and rendering of the services is initiated and completed according to the schedule set by the employee. Expenditures made by the employee in furtherance of the move under the pre-approved budget are deducted from the budget.

The method of the present disclosure enables an employer to develop a list of authorized services focused on the employee's relocation needs and a realistic budget, which can be adjusted if needed. After the budget is approved by the employee, the move is authorized to the third party relocation company, after which the employee self-manages the move. Upon completion of the relocation, any balance in the employee's budget is returned to the employer or paid to the employee, at the employer's election.

Today's market to recruit and retain younger, highly-educated and skilled employees is highly competitive. Many, if not most of these potential employees, as well as existing ones, tech savvy for the most part, would welcome the opportunity to self-manage their own moves. Employers must be sensitive to the desire and need of these employees to self-manage their own relocation, whether domestic or international. Employers need a relocation plan rather than a general policy which may be difficult to apply without making exceptions. The goal of the method disclosed here is to develop an overall plan designed to meet and cover all essential services needed to establish an efficient, cost-effective relocation, self-managed by the employee. The plan will cover all essential services, where applicable, such as household goods shipment, auto shipment, temporary housing, lease cancellation, home finding trip, rental assistance, travel to new location, home sale referral, miscellaneous allowance and expense management.

Relocation discussions may occur during the recruiting process when sourcing a position within an organization. And of course when it is necessary to relocate existing employees. The method of the present disclosure provides human resources staff, recruiters, and hiring managers with a tool to develop a cost estimate for relocating an individual and family. The estimate is based upon the candidate's or existing employee's personal situation, and corporate parameters regarding the relocation components, using cost data from the third party relocation company proprietary database.

When the employer or recruiter initiates a relocation, a corporate template is selected and an online intake form is sent to the candidate being recruited or employee (hereinafter just the term employee will be used). The intake form contains targeted questions based upon the relocation components being offered to the employee. Upon completion of the intake form, the recruiter applies the employee responses to a cost estimate tool which merges the employee responses, corporate parameters or components (services to be provided), and specific cost data to calculate the estimated cost for each of the components. Tax gross up, if applicable, is calculated based upon the company's methodology. The costs plus tax gross up are converted to a budget, which then is approved by the employer.

An employer that wishes to use the method of the present disclosure to manage its company relocation program would overlay its own corporate parameters, narrowing down and tailoring those of the third party relocation service components to fit its corporate culture and recruiting needs. The employer could create one or more templates to fit its general needs. (Examples: Tier 1 for a lower level employee might envision moving 1 automobile, allow a 3 day homefinding trip, and provide 30 days temporary housing. Tier 2 for a mid-level employee might envision moving 2 automobiles, allow a 5 day homefinding trip, provide 60 days of temporary housing, and allow a $5000 miscellaneous allowance. Tier 3 for a higher-level employee might envision moving 2 automobiles, allowing 2 homefinding trips of 7 days total, provide 90 days of temporary housing, and allow a miscellaneous allowance equal to one month's salary.)

Using the third party relocation company's employee intake form, the employer can get additional, specific information from the employee to tailor the chosen corporate parameters/template to the specific employee's needs. For instance, maybe the employee does not have a car, but needs funds for lease cancellation at the departure location. The third party relocation company allows the chosen template to be adjusted accordingly.

Then, once the specific parameters are established for the employee, the employer uses the third party relocation company estimating tool to calculate a budget for the specific move. Taken into account are not only the chosen service components (e.g. temporary housing) and levels (e.g. 60 days), but also the departure and destination locations, number of dependents and other relevant information to calculate the budget using the third party relocation company's proprietary database.

Finally, the budget can be routed for approval within the employer company and then to the employee for agreement, thus creating a personally tailored relocation plan.

Typically, there are numerous relocation components or services to be provided, as will be seen in the examples which will follow here, that can be offered by the employer, although the actual number may vary. The term “component” is meant to refer to the specific service or expense reimbursement which will be offered by the employer, after a specific budget has been applied to the service and has been approved by both the employer and employee. This component will then be part of the overall budget established, including the other components, which can then be accessed and utilized for self-management by the employee in carrying out the relocation. Essentially, the idea is to create a relocation plan for an employee which can be accessed online by the employee through the portal maintained and operated by a third party relocation company. The goal is to have relocation components or services which can be standardized to a reasonable degree. The following components or services are deemed the most useful to illustrate the range of alternatives, and these will be discussed below in reference to implementation of the method of the present disclosure:
House Hunting Trip—Fly
House Hunting Trip—Drive
Miscellaneous Allowance
Lease Cancellation
Temporary Accommodations
Household Goods Move
Vehicle Shipment
Move to New Location—Fly
Move to New Location—Drive
Move to New Location—Flying and Driving
Rental Assistance

### BRIEF DESCRIPTION OF THE DRAWINGS

FIG. 1 is a flow chart showing how the method of the present invention is generally used.

FIG. 2 is a flow chart showing how candidate intake information, corporate parameters and cost data are utilized in budgeting an employee's house hunting trip—fly.

FIG. 3 is similar to FIG. 2 in budgeting an employee's house hunting trip—drive.

FIG. 4 is similar to FIG. 2 in budgeting an employee's miscellaneous allowance.

FIG. 5 is similar to FIG. 2 in budgeting an employee's lease cancellation.

FIG. 6 is similar to FIG. 2 in budgeting an employee's temporary accommodations.

FIG. 7 is similar to FIG. 2 in budgeting an employee's household goods move.

FIG. 8 is similar to FIG. 2 in budgeting an employee's vehicle shipment.

FIG. 9 is similar to FIG. 2 in budgeting an employee's move to new location—fly.

FIG. 10 is similar to FIG. 2 in budgeting an employee's move to new location—drive.

FIG. 11 is similar to FIG. 2 in budgeting an employee's move to new location—fly and drive.

FIG. 12 is similar to FIG. 2 in budgeting an employee's rental assistance.

### EMPLOYEE RELOCATION SELF-MANAGEMENT

As noted, the basic method contemplates that there will be a process for an employer or recruiter (employer) to authorize an employee or potential employee (employee) to self-manage the employee's relocation. The first example of implementation of the method will be described with reference to the component or service of “house hunting—fly,” which refers of course to a house hunting trip to a location that the employee will have to fly to. This will be necessary for the employee to locate a suitable residence in the new location. This will be just one of several of the components or services that may be thought of as corporate “parameters” that the employee will ultimately be charged with self-managing.

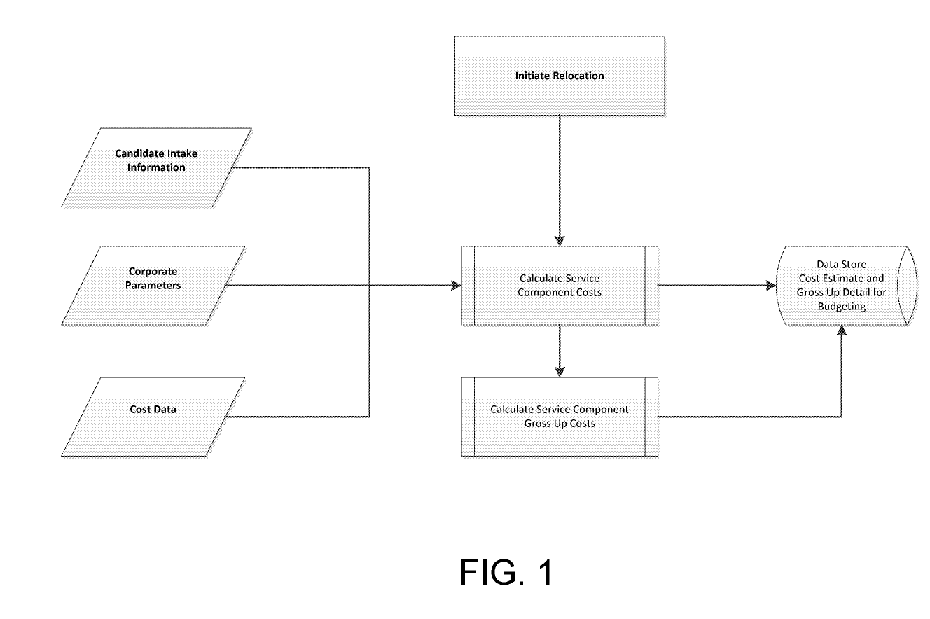

The method begins with the employer initiating the relocation process, and follows the pattern as outlined generally in FIG. 1 for each of the corporate parameters or services to be provided. After completion of all calculations of the service costs, the overall budget can then be determined. The first step is for the employer to initiate the relocation with the third party relocation company, and set up a profile of the employee including name, departure and destination work locations, tax filing status, number of dependents, email address and other information if necessary. Then, the employer selects a corporate template that contains the level of assistance and services that the employer chooses to offer the employee. The employee profile is further customizable based on information obtained from the employee, and this will constitute so-called “candidate intake information.” The candidate is of course the employee or recruit. This information will be most relevant to the particular service to be provided.

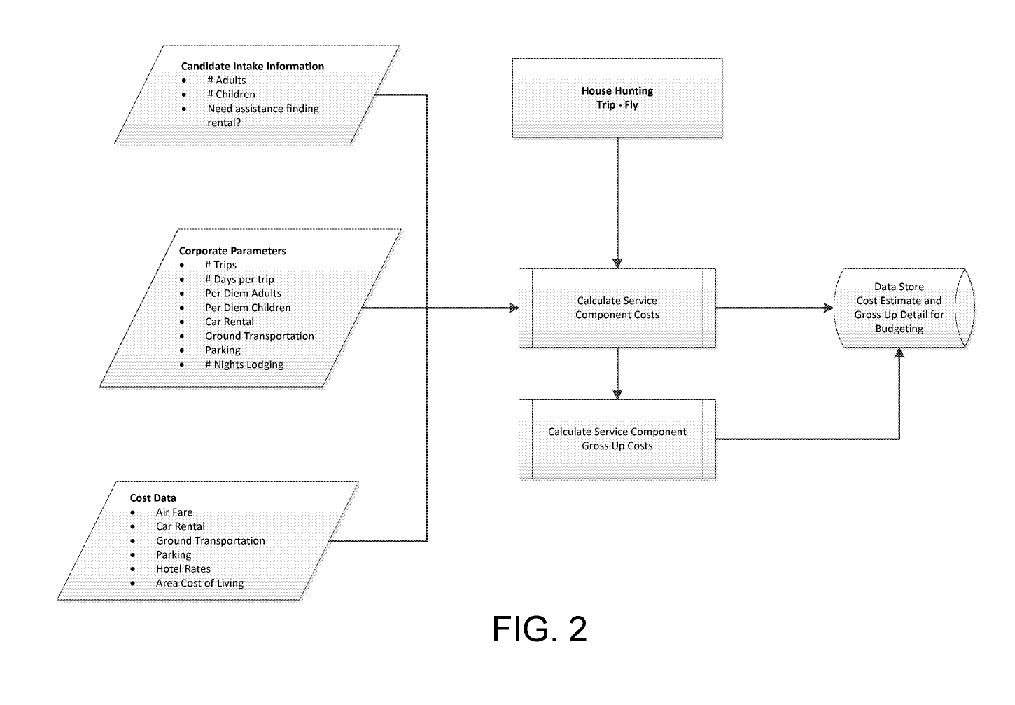

The following example will run through all the essential steps with respect to a house hunting trip where it is necessary for the employee or candidate to fly to the new location to evaluate the availability of suitable housing. A chart showing these steps is illustrated in the accompanying FIG. 2.

### FIG. 2—House Hunting Trip

### Air Transportation and Associated Services

All aspects of the following process are performed via workflow, email notifications and online alerts.
Employer initiates the relocation program (via third party relocation company)
   Employer selects a corporate template for the relocation (corporate parameters necessary to enable computation of vendors or service providers and obtaining cost data for number of trips to find housing, number of days, etc.)
Employer sends Relocation Intake Form to Employee
Employee is asked to provide information related to Finding a New Home
   Number of Adults
   Number of Children
   Will they need rental assistance to find housing?
   Employee returns Intake Form to Employer
Employer reviews Employee response and accepts information (as appropriate) to merge with the corporate parameters/guidelines
   Number of Trips
   Number of Days per Trip
   Adult Per Diem
   Child Per Diem
   Car Rental
   Ground Transportation
   Parking
   Number of Night of Lodging
Third party relocation company proprietary database vetted cost data is used in conjunction with the above data elements to calculate the Cost Estimate
   Airfare
   Car Rental
   Ground Transportation
   Parking
   Hotel Rates
   Area Cost of Living
Employer can modify/override particular line items and/or overall component cost calculation total
Gross Up is calculated based upon the client specific Gross Up methodology
Total costs for service component are saved in the data store for future use as a budget for the relocation component

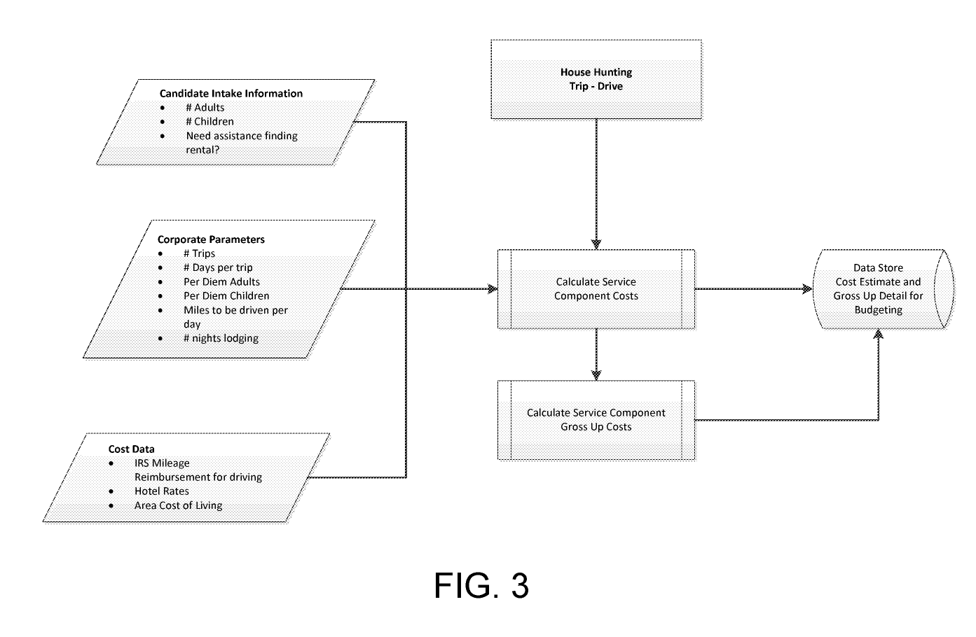

The example as described above and outlined in FIG. 2 is the general format or process followed to determine the vendor costs for the other services to be provided as well for the employee or candidate to self-manage. Not all of these may be required for a particular employee relocation. These are all outlined in detail in the examples below, as well as in FIGS. 3-12. Generally these other services for which vendors must be investigated and cost data assembled for approval by the employer, and agreement by employer management, as well as the employee, include the following:

### FIG. 3—House Hunting Trip—Drive

All aspects of the following process are performed via workflow, email notifications and online alerts
Employer initiates a relocation
   Employer selects a corporate template for the relocation (corporate parameters for number of trips to find housing, etc.)
Employer sends Relocation Intake Form to Employee
Employee is asked to provide information related to Finding a New Home
   Number of Adults
   Number of Children
   Will they need rental assistance to find housing?
   Employee returns Intake Form to Employer
Employer reviews Employee response and accepts information (as appropriate) to merge with the corporate parameters/guidelines
   Number of Trips
   Number of Days per Trip
   Adult Per Diem
   Child Per Diem
   Miles to be driven per day
   Number of Night of Lodging
Third party relocation company proprietary database vetted cost data is used in conjunction with the above data elements to calculate the Cost Estimate
   IRS Mileage Reimbursement rates for driving
   Hotel Rates
   Area Cost of Living
Employer can modify/override particular line items and/or overall component cost calculation total
Gross Up is calculated based upon the client specific Gross Up methodology
Total costs for service component are saved in the data store for future use as a budget for the relocation component

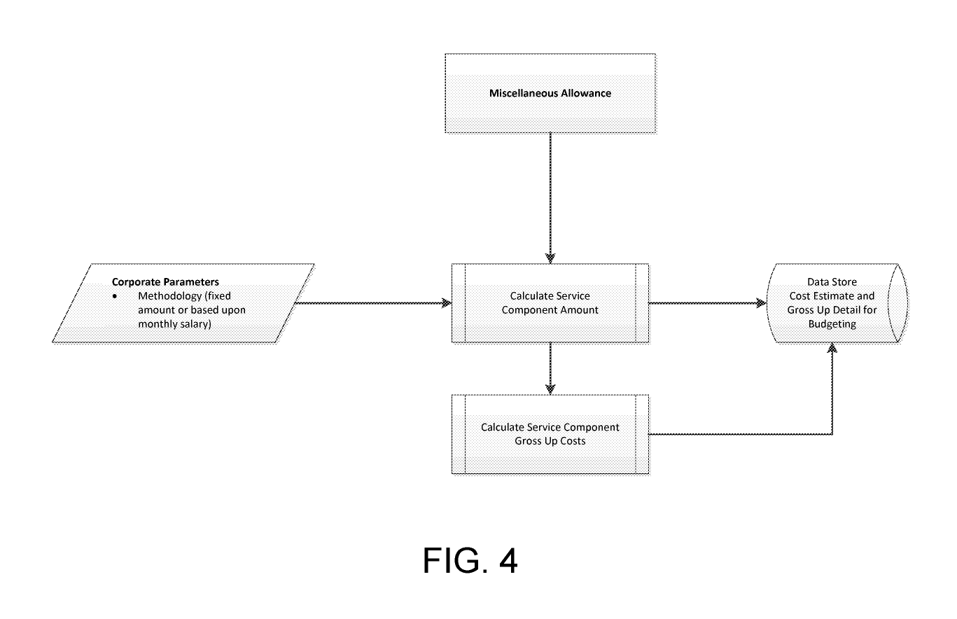

### FIG. 4—Miscellaneous Allowance

All aspects of the following process are performed via workflow, email notifications and online alerts
Employer initiates a relocation
   Employer selects a corporate template for the relocation (corporate parameters for allowance to cover incidental relocation related expenses)
Employer identifies amount to be paid to the Employee in a single payment to cover incidental relocation related expenses
Payment amount may be based upon a calculation related to salary or a fixed amount
Gross Up is calculated based upon the client specific Gross Up methodology
Total costs for service component are saved in the data store for future use as a budget for the relocation component

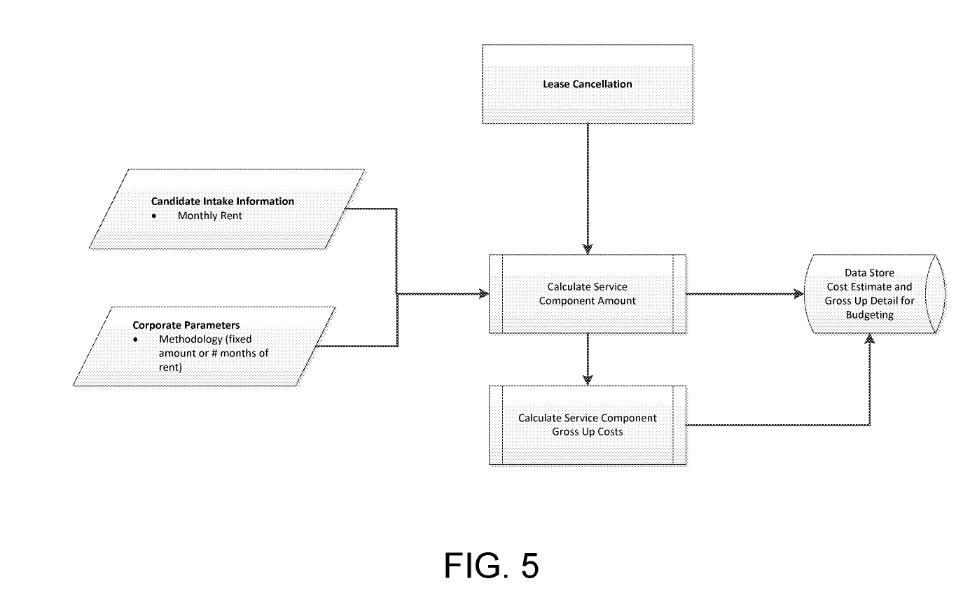

### FIG. 5—Lease Cancellation

All aspects of the following process are performed via workflow, email notifications and online alerts
Employer initiates a relocation
   Employer selects a corporate template for the relocation (corporate parameters for covering lease cancellation charges)
Employer sends Relocation Intake Form to Employee
Employee is asked to provide information related to a rental
   Monthly Rent
   Employee returns Intake Form to Employer
Employer reviews Employee response and accepts information (as appropriate) to merge with the corporate parameters/guidelines
   Lease Cancellation calculation either a fixed amount or based upon number of months of rent
Gross Up is calculated based upon the client specific Gross Up methodology
Total costs for service component are saved in the data store for future use as a budget for the relocation component

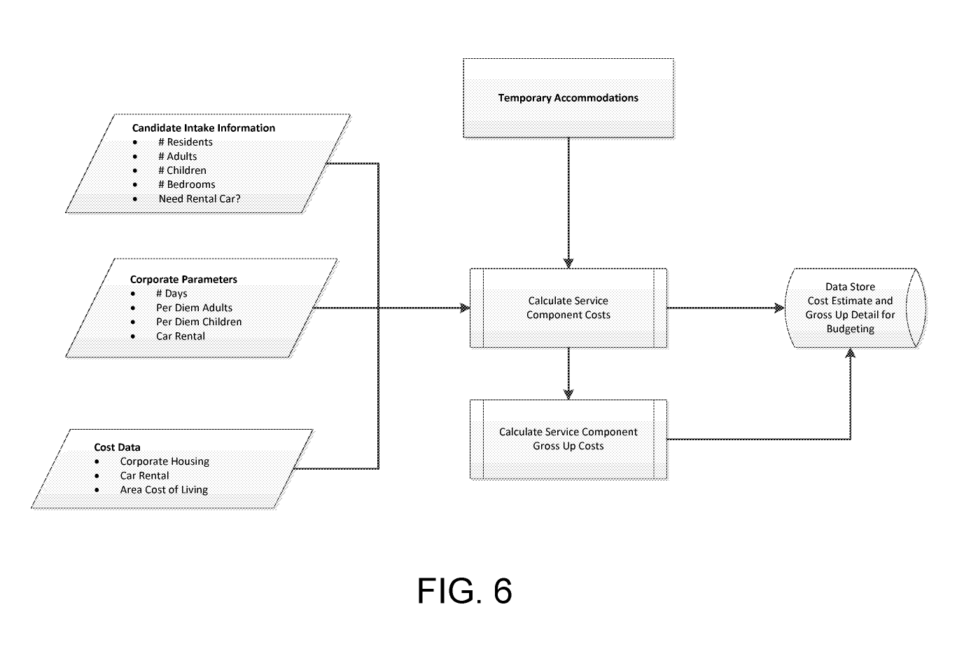

### FIG. 6—Temporary Accommodations

All aspects of the following process are performed via workflow, email notifications and online alerts
Employer initiates a relocation
   Employer selects a corporate template for the relocation (corporate parameters for number of days for housing, etc.)
Employer sends Relocation Intake Form to Employee
Employee is asked to provide information related to Temporary Accommodations
   Number of Residents
   Number of Adults
   Number of Children
   Number of Bedrooms
   Need Rental Car?
   Employee returns Intake Form to Employer
Employer reviews Employee response and accepts information (as appropriate) to merge with the corporate parameters/guidelines
   Number of Days
   Adult Per Diem
   Child Per Diem
   Car Rental
Third party relocation company proprietary database vetted cost data is used in conjunction with the above data elements to calculate the Cost Estimate
   Corporate Housing Rates
   Car Rental
   Area Cost of Living
Employer can modify/override particular line items and/or overall component cost calculation total
Gross Up is calculated based upon the client specific Gross Up methodology
Total costs for service component are saved in the data store for future use as a budget for the relocation component

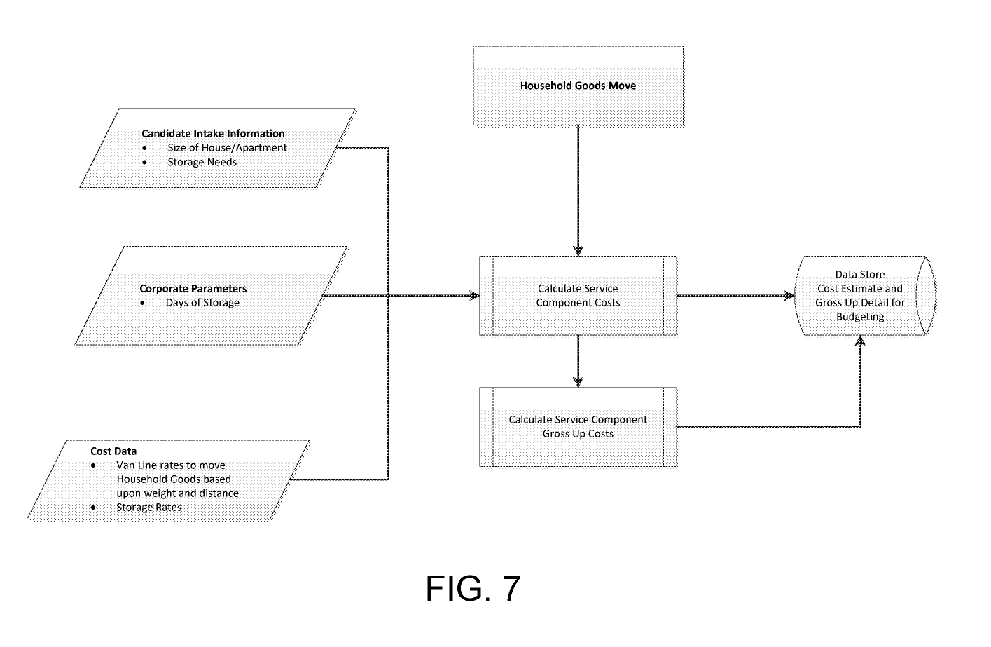

### FIG. 7—Household Goods Move

All aspects of the following process are performed via workflow, email notifications and online alerts
Employer initiates a relocation
   Employer selects a corporate template for the relocation (corporate parameters for number of storage)
Employer sends Relocation Intake Form to Employee
Employee is asked to provide information related to moving their belongings
   Size of House or Apartment
   Need Storage?
      Number of Days
   Employee returns Intake Form to Employer
Employer reviews Employee response and accepts information (as appropriate) to merge with the corporate parameters/guidelines
   Days of Storage
Third party relocation company proprietary database vetted cost data is used in conjunction with the above data elements to calculate the Cost Estimate
   Van Line Rates
   Storage Rates
Employer can modify/override particular line items and/or overall component cost calculation total
Gross Up is calculated based upon the client specific Gross Up methodology
Total costs for service component are saved in the data store for future use as a budget for the relocation component

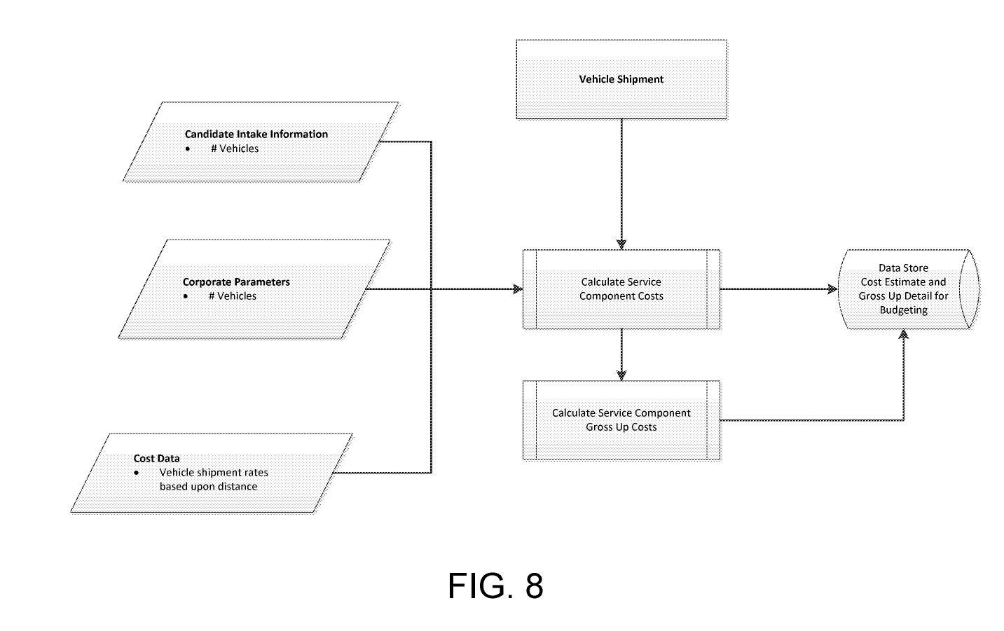

### FIG. 8—Vehicle Shipment

All aspects of the following process are performed via workflow, email notifications and online alerts
Employer initiates a relocation
   Employer selects a corporate template for the relocation (corporate parameters for vehicle shipments)
Employer sends Relocation Intake Form to Employee
Employee is asked to provide information related to a shipping vehicles
   Number of Vehicles to Ship
   Employee returns Intake Form to Employer
Employer reviews Employee response and accepts information (as appropriate) to merge with the corporate parameters/guidelines
   Number of Vehicles
Third party relocation company proprietary database vetted cost data is used in conjunction with the above data elements to calculate the Cost Estimate
   Vehicle Shipper Rates
Employer can modify/override particular line items and/or overall component cost calculation total
Gross Up is calculated based upon the client specific Gross Up methodology
Total costs for service component are saved in the data store for future use as a budget for the relocation component

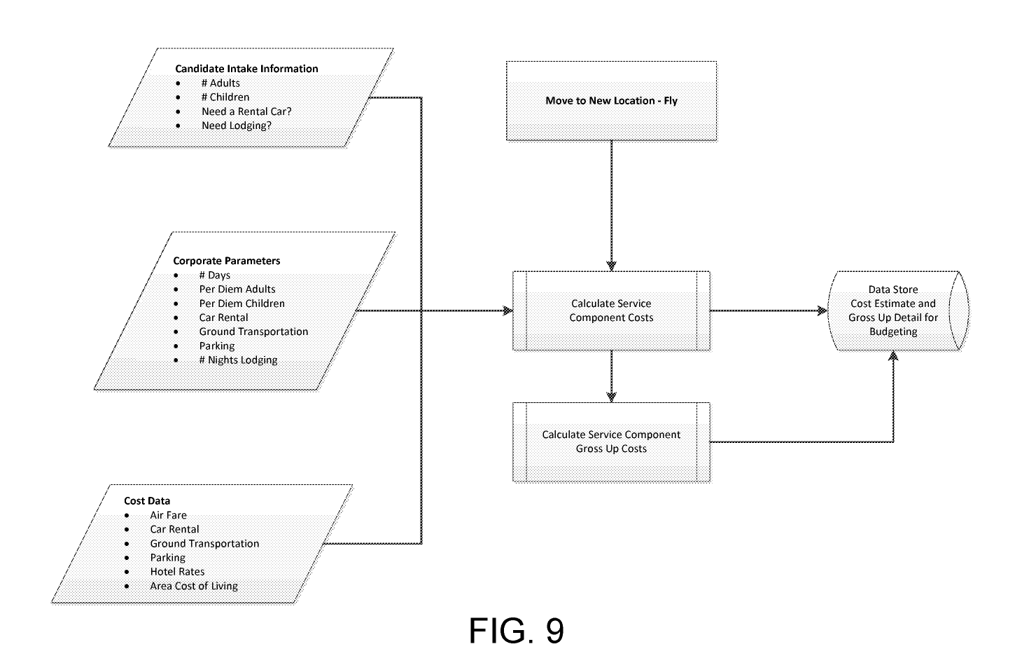

### FIG. 9—Move to New Location—Air Transportation

All aspects of the following process are performed via workflow, email notifications and online alerts
Employer initiates a relocation
   Employer selects a corporate template for the relocation (corporate parameters for moving to the new location)
Employer sends Relocation Intake Form to Employee
Employee is asked to provide information related to Final Move to the New Location when flying
   Number of Adults
   Number of Children
   Need a rental car?
   Need lodging?
   Employee returns Intake Form to Employer
Employer reviews Employee response and accepts information (as appropriate) to merge with the corporate parameters/guidelines
   Number of Days
   Adult Per Diem
   Child Per Diem
   Car Rental
   Ground Transportation
   Parking
   Number of Night of Lodging
Third party relocation company proprietary database vetted cost data is used in conjunction with the above data elements to calculate the Cost Estimate
   Airfare
   Car Rental
   Ground Transportation
   Parking
   Hotel Rates
   Area Cost of Living
Employer can modify/override particular line items and/or overall component cost calculation total
Gross Up is calculated based upon the client specific Gross Up methodology
Total costs for service component are saved in the data store for future use as a budget for the relocation component

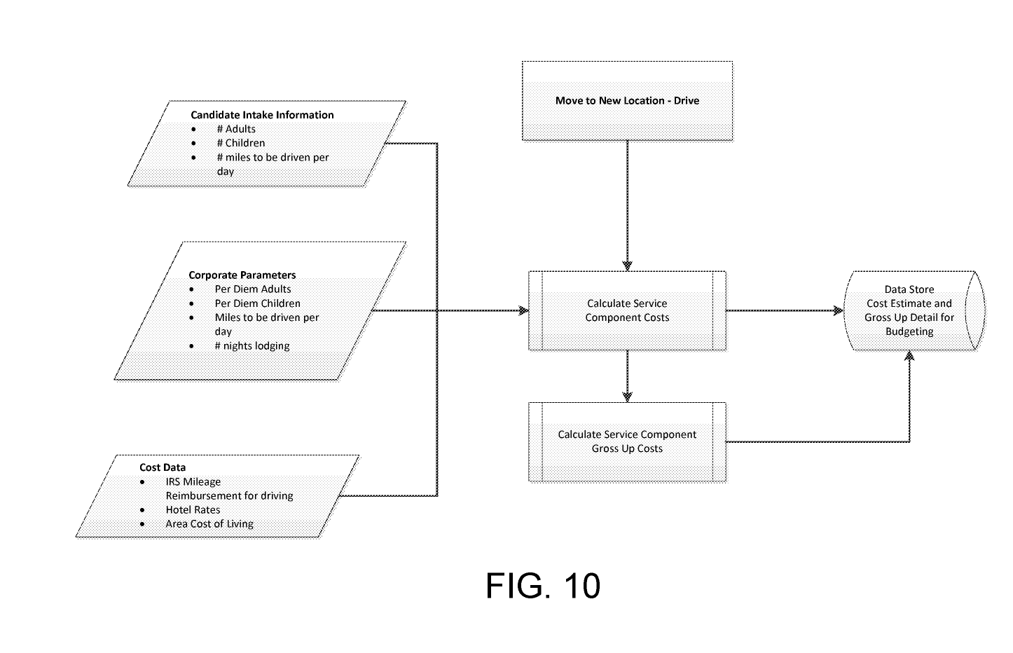

### FIG. 10—Move to New Location—Drive

All aspects of the following process are performed via workflow, email notifications and online alerts
Employer initiates a relocation
   Employer selects a corporate template for the relocation (corporate parameters for number of trips to find housing, etc.)
Employer sends Relocation Intake Form to Employee
Employee is asked to provide information related to Final Move to the New Location when driving
   Number of Adults
   Number of Children
   Number of miles expected to drive per day
   Employee returns Intake Form to Employer
Employer reviews Employee response and accepts information (as appropriate) to merge with the corporate parameters/guidelines
   Adult Per Diem
   Child Per Diem
   Miles to be driven per day
   Number of Night of Lodging
Third party relocation company proprietary database vetted cost data is used in conjunction with the above data elements to calculate the Cost Estimate
   IRS Mileage Reimbursement rates for driving
   Hotel Rates
   Area Cost of Living
Employer can modify/override particular line items and/or overall component cost calculation total
Gross Up is calculated based upon the client specific Gross Up methodology
Total costs for service component are saved in the data store for future use as a budget for the relocation component

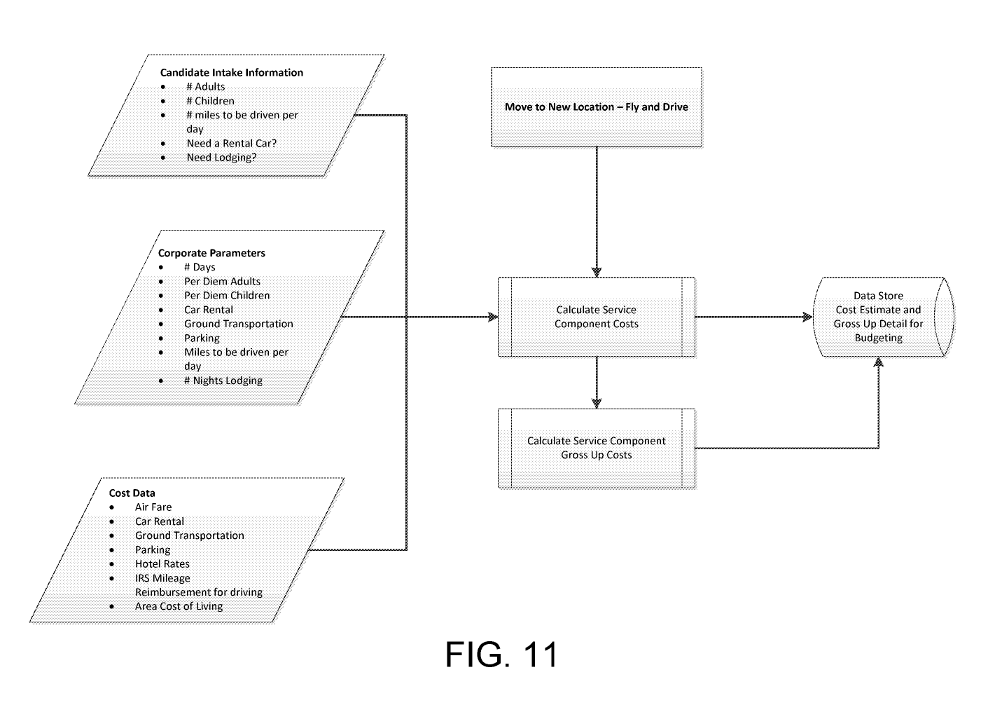

### FIG. 11—Move to New Location—Fly and Drive

All aspects of the following process are performed via workflow, email notifications and online alerts
Employer initiates a relocation
   Employer selects a corporate template for the relocation (corporate parameters for moving to the new location)
Employer sends Relocation Intake Form to Employee
Employee is asked to provide information related to Final Move to the New Location
   For those flying
      Number of Adults
      Number of Children
      Need a rental car?
      Need lodging?
   For those driving
      Number of Adults
      Number of Children
      Number of miles expected to drive per day
   Employee returns Intake Form to Employer
Employer reviews Employee response and accepts information (as appropriate) to merge with the corporate parameters/guidelines
   For those flying
      Number of Days
      Adult Per Diem
      Child Per Diem
      Car Rental
      Ground Transportation
      Parking
      Number of Night of Lodging
   For those driving
      Adult Per Diem
      Child Per Diem
      Miles to be driven per day
      Number of Night of Lodging
Third party relocation company proprietary database vetted cost data is used in conjunction with the above data elements to calculate the Cost Estimate
   Airfare
   Car Rental
   Ground Transportation
   Parking
   Hotel Rates
   IRS Mileage Reimbursement rates for driving
   Area Cost of Living
Employer can modify/override particular line items and/or overall component cost calculation total
Gross Up is calculated based upon the client specific Gross Up methodology
Total costs for service component are saved in the data store for future use as a budget for the relocation component

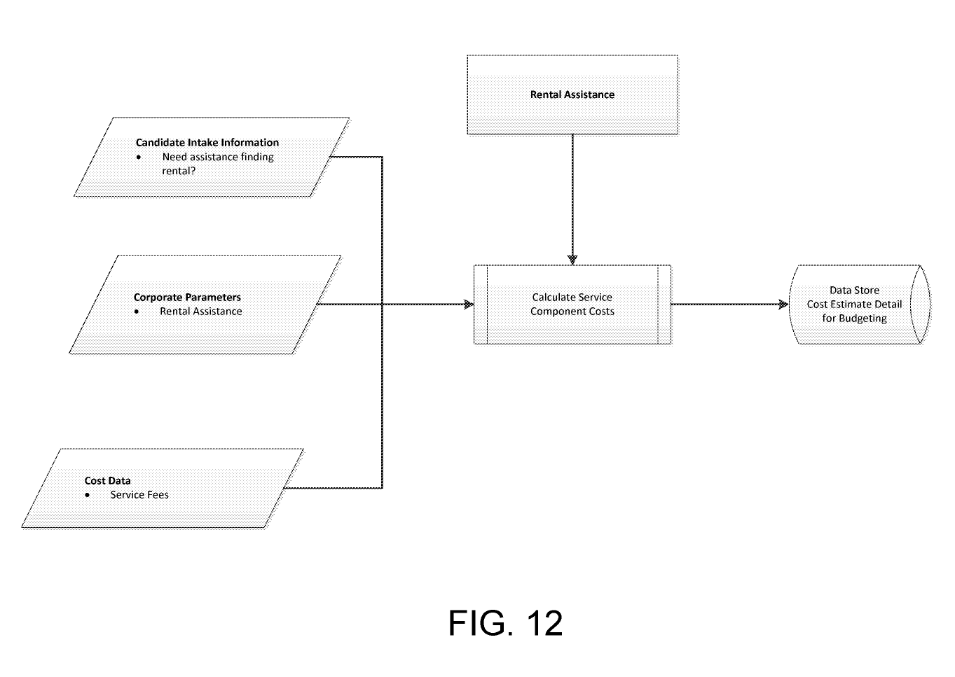

### FIG. 12—Rental Assistance

All aspects of the following process are performed via workflow, email notifications and online alerts
Employer initiates a relocation
Employer sends Relocation Intake Form to Employee
Employee is asked to provide information related to Finding a New Home
   Need assistance finding a rental property?
Employer reviews Employee response and selects core/flex options available for rental assistance. Fee based service
Total costs for service component are saved in the data store for future use as a budget for the relocation component

What is claimed is:

1. A method for use by an employer in establishing a plan to enable an employee to self-manage the employee's relocation comprising:
approving service providers for each service to be rendered in the employee's relocation;
establishing an overall budget to complete the relocation based upon cost estimates from the third party relocation company proprietary database; and
granting the employee permission to use the budget and the service providers so the employee may thereby self-manage the employee's relocation.

2. The method of claim 1 further including the step of receiving intake information about the employee's needs to complete the relocation before the step of establishing an overall budget to complete the relocation.

3. The method of claim 2 further including the step of providing the overall budget and the service providers to the employee after the step of establishing an overall budget to complete the relocation.

4. The method of claim 3 further including the step of securing agreement from the employee to use the service providers and the overall budget for relocation established by the employer.

5. The method of claim 4 wherein the step of granting the employee permission to use the budget and the service providers so the employee may thereby self-manage the employee's relocation is monitored by the employer.

6. A method for use by an employer in establishing a plan to enable an employee to self-manage the employee's relocation comprising:
selecting service providers for each service to be provided in the employee's relocation;
establishing an overall budget to complete the relocation based upon cost estimates from the service providers;
providing the overall budget and the service providers for approval by the employee;
securing agreement from the employee to use the service providers and the overall budget for relocation established by the employer; and
granting the employee permission to use the budget and service providers so the employee may thereby self-manage the employee's relocation.

7. A method for use by a relocation company in facilitating a plan for an employer to enable an employee to self-manage the employee's relocation comprising:
selecting service providers for each service authorized by the employer to be provided in the employee's relocation;
establishing the overall budget in conjunction with the employer's approval to complete the relocation based upon cost estimates from the service providers;
providing the overall budget from the service providers approved by the employer for approval by the employee;
securing agreement from the employee to use the service providers and the overall budget for relocation established by the employer; and
providing a platform for the employee to use the budget and service providers so the employee may thereby self-manage the employee's relocation.
